(19) United States
(12) Patent Application Publication
(10) Pub. No.: US 2003/0233532 A1
(43) Pub. Date: Dec. 18, 2003

(54) System for processing instructions in a program

(76) Inventors: Marc A.G. Duranton, Veldhoven (FR); Laurent Pasquier, Asnieres-Sur-Seine (FR); Valerie Rivierre, Vincennes (FR); Qin Zhao, Charenton Le Pont (FR)

Correspondence Address: PHILIPS INTELLECTUAL PROPERTY & STANDARDS, P.O. BOX 3001, BRIARCLIFF MANOR, NY, 10510, US

(21) Appl. No.: 10/372,544

(22) Filed: Feb. 24, 2003

(30) Foreign Application Priority Data
Feb. 26, 2002 (FR) 0202395

(51) Int. Cl. G06F 9/30

(52) U.S. Cl. 712/214

(57) ABSTRACT

The invention relates to a processing system for processing program instructions (I1) by calculating units (16). To enable constraints of the real-time type to be satisfied, points in time (t1) at which the instructions have to be executed are defined, and the instructions are in fact executed at these points in time. To this end, the processing system comprises means (14) for comparing these points in time with an execution time (13), and firing means (15) suitable for causing the instructions to be executed, or not, by the calculating units as a function of the comparison. A block of instructions is associated with at least one tag representing one point in time at which it has to be executed. The tags are stored in a content-addressable memory (22) that is suitable for comparing a given tag with the execution time, and for supplying a descriptor (B1*) describing the block of instructions corresponding to this given tag when there is a match between this given tag and the execution time.

The invention relates to a processing system comprising at least one calculating unit intended to execute at least one block comprising one or more instructions, said block being associated with at least one point in time at which it has to be executed by said calculating unit, said point in time being determined from a scheduling time.

It also relates to a processing method comprising at least one execution step performed by a calculating unit, which unit is intended to execute at least one block comprising one or more instructions, which block is associated with at least one point in time at which it has to be executed by said calculating unit, said point in time being determined from a scheduling time.

It also relates to a program comprising program code instructions for executing the steps of the method.

One application of the invention is, for example, in a system intended for an application in which there are real-time constraints, such as a device for processing video data. An image rendering processor, for example, may form a device of this kind for processing video data. The image rendering processor may, for example, be included in a decoder, in a set top box for television or in a television set.

Processing systems comprise one or more calculating units intended to execute instructions forming at least one program. In some such systems it is possible to establish, in a scheduling step, the calculating units by which the instructions have to be executed and the points in time at which said instructions have to be executed. European patent application EP 0 840 213 describes, in particular, a processing system in which a scheduling step of this kind is implemented. The points in time at which the instructions have to be executed are determined from a scheduling time that is formed by a clock signal. The points in time in question thus correspond to certain numbers of clock cycles.

The object of the invention to which EP 0 840 213 relates is to determine the points in time at which the instructions have to be executed in order to cause the instructions to be executed in an order that is defined by these points in time. However, in this patent application the points in time at which the instructions have to be executed are taken into account only for the purpose of defining the order in which they are executed by a calculating unit, which means that an instruction may actually be executed at a point in time different than that defined in the scheduling step. There is a disadvantage in this, particularly in systems intended for applications in which there are real-time constraints. For example, in a system devoted to displaying audio-visual images, it is important for the images displayed on a screen to be synchronized with spoken words. This is difficult to achieve if the instructions are not in fact executed at the points in time defined in the scheduling step.

European patent application EP 0 959 575 decribes a processing system in which an instruction is in fact executed at the point in time at which it has to be executed. Each instruction is associated with a point in time at which it has to be executed, and this point in time at which the instruction has to be executed is compared with a reference time. When the point in time at which the instruction has to be executed is equal to the reference time, the instruction is executed. The system uses a comparator or an arithmetic logic unit, which compares, for each instruction, the point in time at which this instruction has to be executed with the reference time. Such a system requires a program in order to compare the points in time at which instructions have to be executed with the reference time, which is a drawback, because such a program slows the system down and increases the power consumption of the system.

It is an object of the invention to propose a processing system, which is faster and consumes less power.

The invention proposes a processing system comprising at least one calculating unit intended to execute at least one block comprising one or more instructions, said block being associated with at least one point in time at which it has to be executed by said calculating unit, said point in time being determined from a scheduling time, said processing system comprising means for comparing said point in time with an execution time linked to the scheduling time, and firing means for causing said block of instructions to be executed, or not, by the calculating unit as a function of the comparison, a block of instructions being associated with at least one tag representing at least one point in time at which it has to be executed, the tags being stored in a content-addressable memory that is suitable for comparing a given tag with the execution time, and for supplying a descriptor describing the block of instructions corresponding to said given tag when there is a match between the given tag and the execution time.

According to the invention, a content-addressable memory, such as an associative memory, for example, comprises comparison means and firing means. In this way, the comparison and firing, being performed by a hardware device, are operations that are faster and consume less energy than if they were performed by software means. This is because a software means would perform a considerable number of operations to compare an execution time with a point in time at which a block of instructions has to be executed. Consequently, to cause a block of instructions comprising a given number of instructions to be executed, it is possible that a software means would require a number of operations of the same order as the given number of instructions. This is not ideal in terms of speed or energy consumption.

In an advantageous embodiment of the invention, a block of instructions is also associated with at least one identifier that indicates the calculating unit by which it has to be executed, the descriptor being transmitted to an instruction sequencer suitable for causing the instructions in that block which corresponds to said descriptor to be executed by that calculating unit which corresponds to said identifier.

This embodiment is particularly advantageous when there are a plurality of calculating units executing different blocks of instructions in parallel. The identifiers, which may be stored in, for example, the blocks of instructions or the instruction sequencer, enable the instruction sequencer to establish the calculating unit or units to which it has to transmit the instructions in given blocks of instructions. The instruction sequencer thus ensures effective and efficient communication between the calculating units and a central memory in which the blocks of instructions are stored.

These and other aspects of the invention are apparent from and will be elucidated with reference to the embodiments described hereinafter.

In the drawings, which are given by way of non-limiting example:

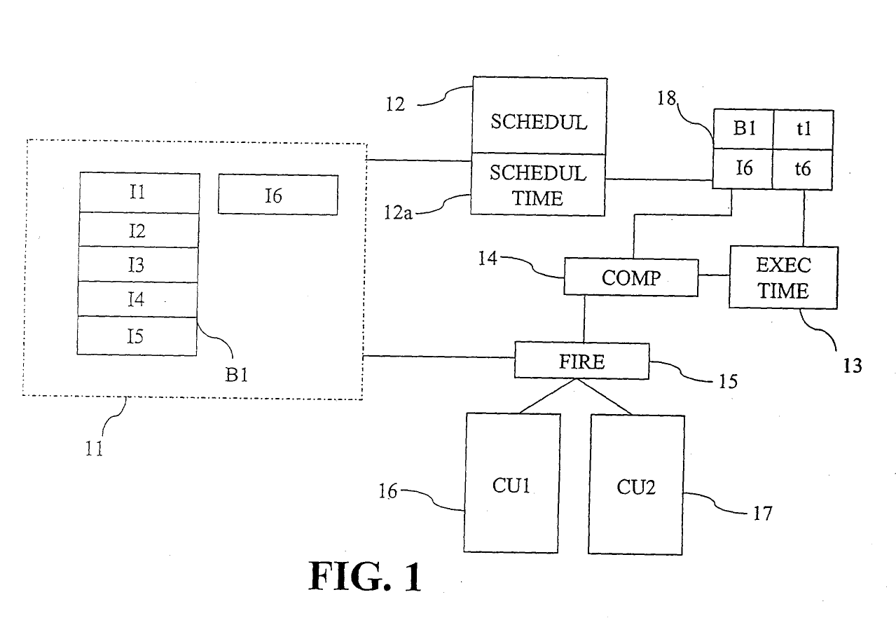

FIG. 1 is a block diagram illustrating the features of a processing system according to the invention.

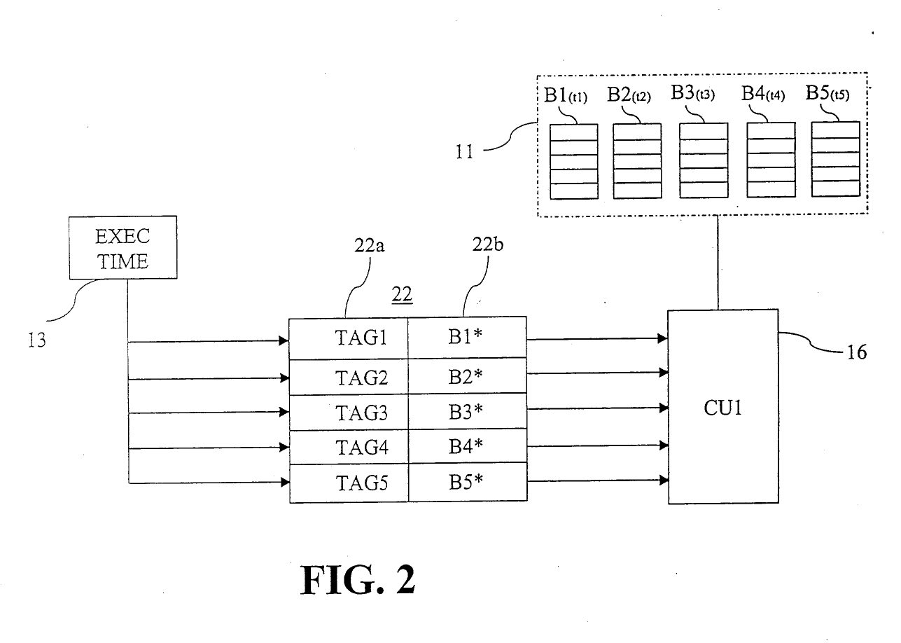

FIG. 2 shows an embodiment of the comparison and firing means of FIG. 1.

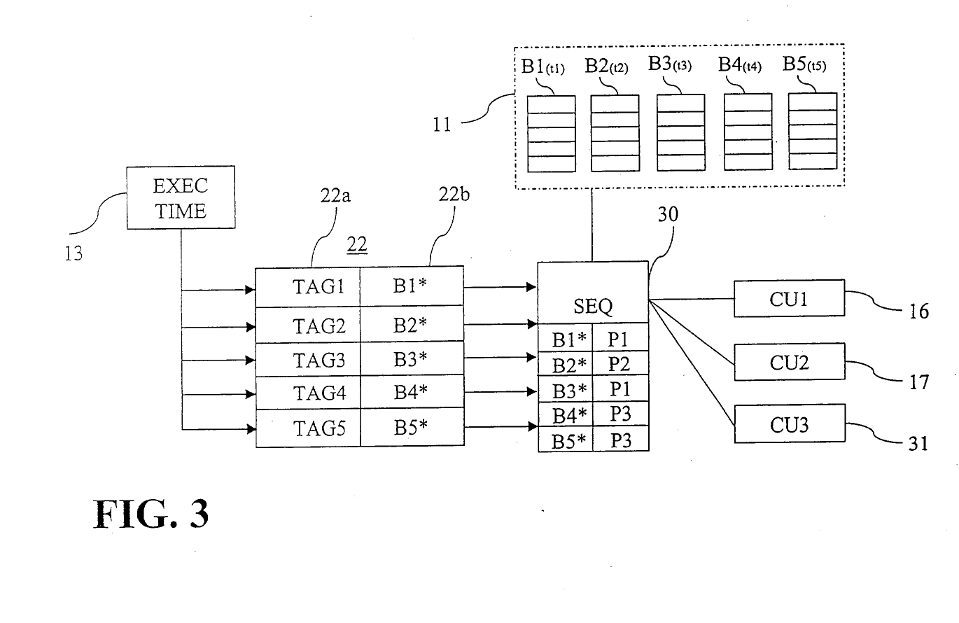

FIG. 3 shows a processing system according to the invention comprising a plurality of calculating units.

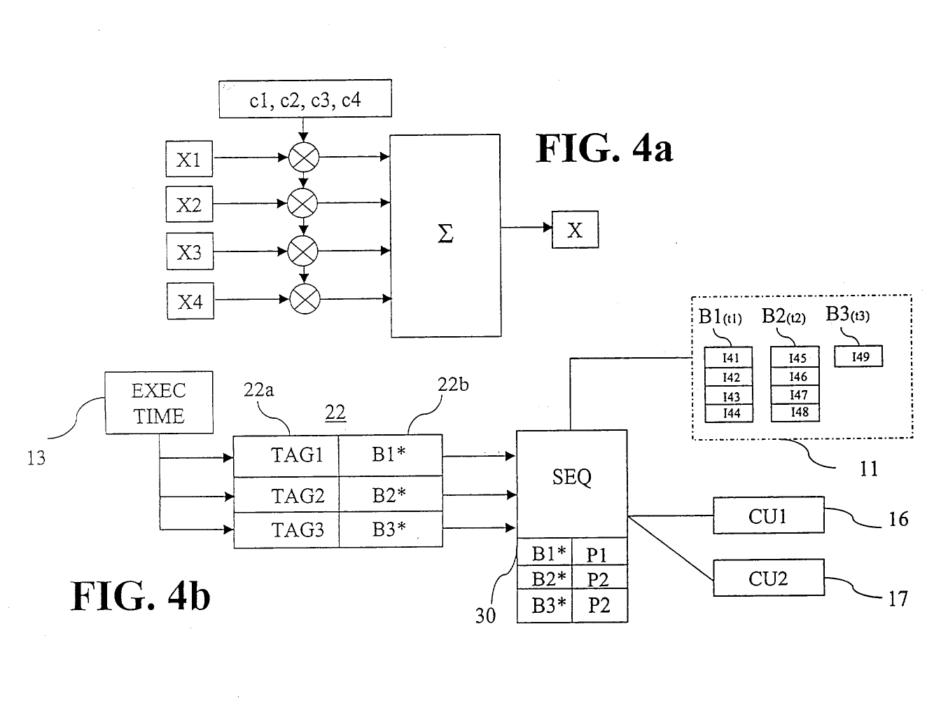

FIGS. 4a and 4b show an example of how the processing system of FIG. 3 may be used in an image rendering processor.

FIG. 1 shows a processing system according to the invention. Such a processing system comprises a program 11 comprising a block of instructions B1 and an instruction I6, comparison means 14, firing means 15, a first calculating unit 16 and a second calculating unit 17. The block of instructions B1 comprises five instructions I1 to I5. It should be noted that the term “block of instructions” covers both a block comprising a plurality of instructions and a block comprising only a single instruction. Instruction I6, for example, is a block of instructions comprising only a single instruction.

Also shown in FIG. 1 is a scheduling device 12. This device is responsible for defining which calculating unit a block of instructions has to be executed by and the point in time at which it has to be executed. The system according to the invention may comprise such a scheduling device 12. When this is the case, it is, in particular, possible for the scheduling performed to be dynamic, i.e. to take place during the running of the program 11. The scheduling device 12 may also be external to the system according to the invention. When this is the case, the scheduling performed is static, i.e. takes place prior to the running of the program 11. When this is the case, information supplied by the scheduling device 12 is accessible to the system according to the invention. Such information relates in particular to the calculating unit by which a block of instructions has to be executed, the point in time at which it has to be executed and a scheduling time 12a that is used by the scheduling device. This information is obtained in a scheduling step performed by the scheduling device 12, which scheduling step may, for example, be performed when the program 11 is compiled.

To define points in time at which the blocks of instructions have to be executed and calculating units that have to execute the blocks of instructions, the scheduling device 12 takes into account:

constraints set by resources, such as the two calculating units 16 and 17,

blocks of instructions to be executed, such as block of instructions B1 and instruction I6,

constraints set by time, such as constraints of the real-time type.

The scheduling device 12 must, therefore, solve a linear program to satisfy these different constraints. A solution of this kind is familiar to the man skilled in the art. Patent application EP 0 840 213, for example, describes how the points in time at which instructions or blocks of instructions have to be executed are defined.

The points in time at which the blocks of instructions have to be executed are determined from the scheduling time 12a. If it is assumed that a length of time T is required to run the program 11, the scheduling time 12a begins, for example, at a point in time zero and goes on to terminate at a point in time T. This being the case, a point in time at which a block of instructions has to be executed is contained between zero and T.

When running the program 11, the points in time at which the blocks of instructions have to be executed are compared with an execution time 13 by the comparison means 14. These points in time may, for example, be stored in a memory 18, which may or may not form part of the scheduling device 12. They may equally well be stored in the blocks of instructions in the program 11 or in some other part of the program 11. When this is the case, the comparison means 14 have access to the program 11 to make the comparison with the execution time 13, which is made by, for example, a temporal comparison program run by software.

The execution time 13 may be a time in real time. It may equally well correspond to a number, which may or may not be a whole number, of cycles of a clock signal. The execution time 13 is linked to the scheduling time 12a. In the example cited above, the execution time 13 may, for example, be the same as the scheduling time 12a in that it begins at a point in time zero and goes on to terminate at a point in time T, with point in time zero representing the beginning of the running of the program 11.

Thus, by taking common time-bases as a basis for defining the points in time at which the blocks of instructions have to be executed and for causing the instructions to be executed by means of the firing device 15, it is possible to cause the blocks of instructions to in fact be executed at the points in time defined by the scheduling device 12. In effect, the firing device 15 causes a block of instructions to be executed by a calculating unit when a predefined criterion establishes a link between the point in time at which the block of instructions has to be executed and the execution time. This predefined criterion may, for example, be a match between said point in time and the execution time 13.

Other criteria may be selected, particularly when a plurality of points in time have been determined for the execution of the blocks of instructions, such as, for example, when the point in time at which the block of instructions has to be executed is defined as being within an interval of time. When this is the case, the firing device 15 may cause the block of instructions to be executed when the point reached in the execution time 13 is within this interval of time.

The firing device 15 may also cause the block of instructions to be executed when there is a predefined difference between the execution time 13 and the point in time at which the block of instructions has to be executed. A certain delay time may in fact be needed between the comparison by the comparison device 14 and the beginning of the execution of the block of instructions by the calculating unit. The predefined difference between the execution time 13 and the point in time at which the block of instructions has to be executed allows for this delay time. It should be noted that the delay time may also be allowed for by subtracting it from the point in time at which the block of instructions has to be executed, as will be seen in detail in FIG. 2. The delay time may also be allowed for in order to define the execution time 13 as a function of the scheduling time 12a, as will also be seen in detail in FIG. 2.

When one of the points in time defined by the scheduling device satisfies the predefined criterion, the firing device 15 accesses the appropriate block of instructions and transmits the said block to the calculating unit that has to execute it. The firing unit 15 may equally well transmit an item of information to the calculating unit that tells it that it must download the instructions in this block of instructions in order to execute them.

FIG. 2 shows a preferred embodiment of the invention. In this embodiment, the comparison means 14 and firing means 15 are formed by a content-addressable memory 22 that comprises a tag part 22a and a data part 22b. In the present example, the program 11 comprises five blocks of instructions B1 to B5, which have to be executed by the first calculating unit 16 at points in time t1 to t5.

The points in time t1 to t5 at which the blocks of instructions have to be executed, which are defined by the scheduling device 12 in FIG. 1, are tagged, that is to say are, for example, coded onto a certain number of bits. In the present example, points in time t1 to t5 correspond to whole numbers of clock cycles and are tagged to obtain tags TAG1 to TAG5 that are coded onto sixteen bits. These tags are stored in the tag part 22a of the content-addressable memory 22. The execution time 13, which is a whole number of clock cycles that is incremented by one at each clock cycle, is also coded onto sixteen bits.

In the data part 22b of the content-addressable memory 22 are stored descriptors B1* to B5* that indicate which block of instructions corresponds to a given tag.

The content-addressable memory 22 operates as follows. At each clock cycle, the execution time 13 is compared with all the tags TAG1 to TAG5. When there is a match between one of the tags TAG1 to TAG5 and the execution time 13, the corresponding descriptor is transmitted to the first calculating unit 16, which then accesses the program 11 to download the block of instructions corresponding to the descriptor in order to execute the block.

If it is assumed that at a given moment there is a match between the execution time 13 and TAG1 and that the transmission of descriptor B1* to the first calculating unit 16 and the downloading of block of instructions B1 by the first calculating unit 16 will require a period Δt, block of instructions B1 will be executed at a point in time t1+Δt. This may be a problem because it is possible, to meet constraints of the real-time type, that what is desired is for block of instructions B1 to be executed at the exact point in time defined by the scheduling device 12.

One solution to this problem consists in making allowance for this period Δt at the time of the scheduling performed by the scheduling device 12 or at the time of the tagging. For example, by subtracting this period At from the point in time t1 at which block of instructions B1 needs to be executed, by tagging the point in time (t1−Δt) and by placing the tag obtained in the tag section 22a of the content-addressable memory 22, it is possible to cause the block of instructions B1 to actually be executed at point in time t1.

Another solution consists in shifting the execution time 13 relative to the scheduling time 12a by the period At. This solution is advantageous when there is only a single calculating unit executing the program 11. This is the case in the example shown in FIG. 2. When more than one calculating unit is required to execute the program 11, the solution in question is only advantageous if the delay times are the same for all the calculating units and are equal to Δt.

In cases where the scheduling time 12a begins at a point in time zero and ends at a point in time T, the execution time 13 begins at a point in time Δt and ends at a point in time T+Δt. The execution of program 11 thus begins at point in time Δt.

Hence, descriptor B1* will be transmitted to the first calculating unit 16 at a point in time t1−Δt and the block of instructions B1 will thus be executed at the point in time t1 defined by the scheduling device 12.

It should be noted that the period At may allow for various factors that depend, in the example shown in FIG. 2, on the content-addressable memory 22, on the first calculating unit 16 and on the program 11.

FIG. 3 shows an advantageous embodiment of the invention. In this embodiment, the block of instructions B1 to B5 may be executed by the first calculating unit 16, the second calculating unit 17 or a third calculating unit 31. An instruction sequencer 30 allows a processing system of this kind representing an advantageous embodiment of the invention to be managed.

The calculating unit by which a block of instructions has to be executed is defined by the scheduling device in a way familiar to the man skilled in the art. This is described in, for example, patent application EP 0 840 213. The calculating units 16, 17 and 31 are identified by identifiers P1, P2 and P3. These identifiers may, for example, be addresses of the calculating units 16, 17 and 31. The instruction sequencer 30 comprises a memory in which an instruction-block descriptor is associated with at least one identifier. In the example shown in FIG. 3, block of instructions B1 has to be executed by the first calculating unit 16, block of instructions B2 by the second calculating unit 17, block of instructions B3 by the first calculating unit 16, block of instructions B4 by the third calculating unit 31 and block of instructions B5 by the third calculating unit 31.

When a descriptor is transmitted to the instruction sequencer 30 then, in the same way as was described in the description of FIG. 2, the instruction sequencer 30 accesses the program 11 to download the block of instructions corresponding to this descriptor, and transmits this block of instructions to the calculating unit corresponding to the identifier associated with this descriptor. It should be noted that the instruction sequencer 30 may equally well transmit an item of information to the calculating unit corresponding to the identifier associated with said descriptor. This item of information indicates that the calculating unit in question has to execute the block of instructions corresponding to said descriptor. This calculating unit then assumes responsibility for accessing the program 11 to download the block of instructions concerned in order to execute it.

The instruction sequencer 30 may be a state machine, for example. When it receives a descriptor, the instruction sequencer 30 changes from an idle state to a reading state. While in this reading state, the instruction sequencer 30 accesses the program 11 to read the instructions in the block of instructions corresponding to the descriptor. When all the instructions have been read, the instruction sequencer 30 changes to a writing state in order to transmit the instructions to the calculating unit corresponding to the identifier associated with the descriptor concerned. Other solutions may be envisaged. The instruction sequencer may, for example, read a first instruction in the block of instructions, transmit this first instruction to the calculating unit, and then read a second instruction and so on until all the instructions in the block of instructions concerned have been transmitted to the calculating unit.

It should also be noted that the identifiers for the calculating units may be stored t points other than the instruction sequencer 30, such as in the data part 22b of the content-addressable memory 22, in the blocks of instructions, or again in a memory external to the instruction sequencer 30. In each of these cases, the way in which the processing system will operate can readily be deduced from way in which it operates as described above.

FIGS. 4a and 4b show an example of the use of the processing system according to the invention in an image rendering processor.

There are various formats for the display of video data. There is, for example, an American digital television standard ATSC that defines eighteen different broadcasting formats, such as the standard format where an image comprises 480 lines each of 720 pixels, or the high-definition format where an image comprises 1080 lines each of 1920 pixels. When video data is broadcast in the high-definition format, it has to be converted to the standard format to enable it to be shown on a television set whose screen is not compatible with the high-definition format. An image rendering processor allows particularly such a conversion to be made.

FIG. 4a shows an operation that is performed by the image rendering processor for the purpose of obtaining a value X for a given pixel in a standard-definition image as a function of the values X1 and X2 of pixels situated above the given pixel in a high-definition image and of the values X3 and X4 of pixels situated below the given pixel in a high-definition image. The values of the pixels may be gray levels, for example. This operation enables the value X defined by the following formula to be obtained:

X=c1X1+c2X2+c3X3+c4X4.

In this formula, c1, c2, c3 and c4 are filtering coefficients that may be stored in, for example, a memory that can be accessed by the second calculating unit 17.

FIG. 4b shows a processing system according to the invention that enables instructions to be scheduled and executed in order to perform this operation. The first block of instructions B1 comprises four instructions I41 to I44 that are defined as follows:

I41: load X1

I42: load X2

I43: load X3

I44: load X4

By means of these instructions I41 to I44, the values X1 to X4 are loaded into the first calculating unit 16 at a point in time t1 defined by the scheduling device 12.

The second block of instructions B2 comprises four instructions I45 to I48 that are defined as follows:

I45: multiply X1 and c1

I46: multiply X2 and c2

I47: multiply X3 and c3

I48: multiply X4 and c4

By means of these instructions I45 to I48, which are executed by the second calculating unit 17 at a point in time t2 defined by the scheduling device 12, the values c1X1, c2X2, c3X3 and c4X4 are obtained. The four instructions I45 to I48 may, for example, be executed simultaneously if the second calculating unit 17 is able to execute different instructions in parallel.

The third block of instructions B3 comprises one instruction I49 that is defined as follows:

I49: add c1X1, c2X2, c3X3 and c4X4.

This instruction I49 is executed by the second calculating unit 17 at a point in time t3 defined by the scheduling device 12.

The points in time t1, t2 and t3 may be defined as follows, for example. If it is assumed that the value X must be available at a point in time T0, that the loading operations require a period Δt1, that the multiplications require a period Δt2 and that the addition requires a period Δt3, points in time t1, t2 and t3 are defined by the formulas:

t1=T0−Δt1−Δt2−Δt3

t2=T0−Δt2−Δt3

t3=T0−Δt3

In this example, the execution time 13 is shifted by a period Δt relative to the scheduling time 12a. This period Δt corresponds to the period Δt as defined in the description of FIG. 2. If the execution time 13 is a clock signal, this period Δt may correspond to one or more clock cycles. The points in time t1, t2 and t3, which correspond to numbers of clock cycles, are coded onto sixteen bits to produce the tags TAG1, TAG2 and TAG3. These tags are placed in the tag part 22a of the content-addressable memory 22. The execution time 13 is likewise coded onto sixteen bits.

The running of the program begins at point in time Δt. When there is a match between the execution time 13 and t1, descriptor B1* is transmitted to the instruction sequencer 30. For the scheduling device 12, the running of the program 11 begins at point in time zero. Consequently, relative to the scheduling time 12a, the descriptor B1* is in fact transmitted to the instruction sequencer 30 at point in time t1−Δt. In this way, block of instructions B1 is actually executed by the first calculating unit 16 at the point in time t1 defined by the scheduling device 12. The reasoning that applies to blocks of instructions B2 and B3 is similar.

A processing system such as that shown in FIG. 4b may be used in an image rendering processor intended for calculating the values of pixels with a view to enabling the pixels to be shown on a screen. An image rendering processor of this kind may be incorporated in, for example, a decoder, a television set-top box, a television set, a computer central processing unit or a computer monitor. An image rendering processor of this kind may be used in a communications system comprising at least one transmitter suitable for transmitting signals representing at least one image, a transmission network, and a receiver suitable for receiving said signals.

1. A processing system comprising at least one calculating unit (16) intended to execute at least one block (B1) comprising one or more instructions (I1), said block being associated with at least one point in time (t1) at which it has to be executed by said calculating unit, said point in time being determined from a scheduling time (12a), said processing system comprising means (14) for comparing said point in time with an execution time (13) linked to the scheduling time, and firing means (15) for causing said block of instructions to be executed, or not, by the calculating unit as a function of the comparison, a block of instructions being associated with at least one tag (TAG1) representing at least one point in time at which it has to be executed, the tags being stored in a content-addressable memory (22) that is suitable for comparing a given tag with the execution time, and for supplying a descriptor (B1*) describing the block of instructions corresponding to said given tag when there is a match between the given tag and the execution time.

2. A processing system as claimed in claim 1, characterized in that a block of instructions is also associated with at least one identifier (P1) that indicates the calculating unit by which it has to be executed, the identifier being transmitted to an instruction sequencer (30) that is suitable for causing the instructions in that block which corresponds to said descriptor to be executed by that calculating unit which corresponds to said identifier.

3. A processing method comprising at least one execution step that is performed by a calculating unit intended to execute at least one block comprising one or more instructions, which block is associated with at least one point in time at which it has to be executed by said calculating unit, said point in time being determined from a scheduling time, said processing method being characterized in that it comprises a step for comparing said point in time with an execution time linked to the scheduling time, and a firing step for causing said block of instructions to be executed, or not, by the calculating unit as a function of a result of said comparison step, a block of instructions being associated with at least one tag representing at least one point in time at which it has to be executed, the tags being stored in a content-addressable memory that is suitable for comparing a given tag with the execution time, and for supplying a descriptor describing the block of instructions corresponding to said given tag when there is a match between the given tag and the execution time.

4. A processing method as claimed in claim 3, characterized in that a block of instructions is also associated with at least one identifier that indicates the calculating unit by which it has to be executed, the identifier being transmitted to an instruction sequencer that is suitable for causing the instructions in that block which corresponds to said descriptor to be executed by that calculating unit which corresponds to said identifier.

5. A program comprising program code instructions for executing the steps of the method claimed in claim 3 when said program is run on a microprocessor.

6. An image rendering processor comprising a processing system as claimed in claim 1 or 2.

7. A set-top box for television comprising at least one image rendering processor as claimed in claim 6.

8. A device comprising at least one screen intended to display images and an image rendering processor as claimed in claim 6.

9. A communications system comprising at least one transmitter suitable for transmitting signals representing at least one image, a transmission network, a receiver suitable for receiving said signals and an image rendering processor as claimed in claim 6.
